(19) United States
(12) Patent Application Publication
(10) Pub. No.: US 2006/0001786 A1
(43) Pub. Date: Jan. 5, 2006

(54) Display device comprising a light guide

(75) Inventor: Tijsbert Mathieu Henricus Creemers, Nijmegen (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/524,070

(22) PCT Filed: Jul. 4, 2003
(86) PCT No.: PCT/IB03/03100

§ 371 Date: Feb. 9, 2005

(30) Foreign Application Priority Data
Aug. 14, 2002 (EP) 020783601

(51) Int. Cl. G02F 1/13

(52) U.S. Cl. 349/1

(57) ABSTRACT

A display device comprises row (5) and column (6) electrodes and a movable element (3) and means (17) for supplying voltages to the electrodes. A controllable image element is formed thereby on a crossing of the electrodes. In dependence on driving pulses received by the electrodes the movable element can be set either to the front plate or the back plate. On one side of the light guide light from a light source is coupled in the light guide; when the movable element is in contact with the light guide light is tapped from the light guide at that place. The display device can be addressed by a multiple line addressing scheme. By evenly distributing the respective lines of the different groups over the display, the homogeneity of the display is improved. In case this distribution of rows is applied to a color sequential dynamic foil display the color flash effect is reduced.

The invention relates to a dynamic foil display device as defined in the pre-characterizing part of Claim 1. The invention also relates to a method for operating a dynamic display device.

A dynamic foil display device of the type mentioned in the opening paragraph is known from international patent application WO 00/38163.

The known dynamic foil display device comprises a light source, a light guide, a second plate which is situated at some distance from the light guide and, between said two plates, a movable element in the form of a membrane. By applying voltages to addressable electrodes on the light guide, the second plate, and an electrode on the membrane, the membrane can be locally brought into contact with the first plate, or the contact can be interrupted. In operation, light generated by the light source is coupled in the light guide. At locations where the membrane is in contact with the light guide, light is decoupled from said light guide. This enables an image to be represented. A possible selection method for selecting the locations of the membrane at the crossing areas of the addressable electrodes is a multiple line addressing method. Gray scales can be obtained by the multiple line addressing method in combination with pulse width modulation. In this case, a picture is displayed at a frame rate of 60 Hz. A first voltage is supplied to a first line. At t=0 a first voltage V0 is supplied to a row electrode. This will activate the line corresponding to said row electrode. Simultaneously, voltages Von for those crossing areas where the pixels have to be turned on, are supplied to the column electrodes crossing said row electrode. Application of a Vhold at either electrode preserves the state of the pixel. At t=t1 the electrode is supplied with a voltage Voff. This will blank the line. The blanking time takes ts. After a short waiting time td the line is activated again. The video information can then be changed for each electrode crossing the relevant row electrode. Thus, the first time the pixel can be 1τ on, the second time 2τ off, the third time 4τ on etc. For an 8-bit gray scale a complete cycle comprises for example, 8 sub-periods of lengths 2,4,8,16,32,64,128τ. Furthermore, two sub-periods are separated by an off-on sequence taking τs+τd+τs. These steps are repeated for the other row electrodes of the display device. Multi-line addressing of the dynamic foil display device and gray levels can thus be made.

Thereto the lines of the dynamic foil display device are interconnected in a number of groups of spatially subsequent addressed lines and the individual groups are addressed sequentially. A disadvantage of the known dynamic foil display device is that, in case a uniform gray image has to be displayed, the luminance of subsequent pixels along one of the lines of the display varies along the width of the display device.

It is an object of the invention to provide a dynamic foil display device of the type mentioned in the opening paragraph having improved homogeneity.

To achieve this object, a first aspect of the invention provides a dynamic foil display device as specified in Claim 1. The invention is based on the recognition that there are two causes of light losses in a gray-level dynamic foil display; a first cause is the coupling out of light needed for light generation associated with the picture element and a second cause is the absorption in spacers, glass, and conducting coatings. The first cause much depends on the contents of the image to be displayed. Applying multi-line addressing on spatially adjacent addressed selection electrodes for displaying a predetermined gray value on the display causes a variance in the luminance along a first direction of the display perpendicular to a second, lateral direction. The lateral direction corresponds to the main direction of light flux from the light source in the light guide. Furthermore, in the lateral direction a stepwise variation in the displayed gray value may occur at the position where the first selection electrodes of a new addressing group begin. These step-by-step variations are caused at the position of the first addressed selection electrode of a new group because the first selection electrode of this group is addressed at a later instant than the selection electrodes of the former group, so that light loss through coupling out the light has not yet occurred in the light guide. In case the successively addressed lines of a single addressed group are evenly distributed over the height of the display, the effect of attenuated rays with a first distinct angle with respect to the surface of the light guide is averaged out with non-attenuated rays with a second distinct angle with respect to the surface of the light guide, the second distinct angle being slightly different from the first distinct angle. So, the homogeneity of the dynamic foil display is improved. In this application evenly distributed means distributed in a balanced or impartial way. Further advantageous embodiments of the invention are specified in the dependent claims.

In an embodiment as specified in claim 3 the dynamic foil display device acts as a subfield modulated display. Thus a display element can only turn pixels on and off. In a subfield, a display element can be conditioned to scatter light in the display period. Therefore, an addressing sequence is necessary so that the movable element is locally forced against the light guide when an appropriate voltage is applied between the first and second electrodes in an addressing period. In the subsequent display period, when the light source is emitting light at the selected display element, the movable element scatters light from the light guide to the viewer. In the next subsequent subfield this process is repeated. The weight of the subfield determines how long the light source will emit light. The luminance of a display element may be determined by an input byte of the displayed image. The weight of the subfields corresponds to the weight of the input bits of a display element. When the weight of a bit corresponds to the weight of the subfield at a display element, the movable element will scatter light during the subsequent display period. Since in the new display device all lines are active at the same time, fixed pattern noise in the displayed image can be reduced.

In an embodiment as specified in claim 5 a color image can be displayed in a color-sequential way. In this color-sequential dynamic foil display device the image information can be divided into subfields associated with image information of the two colors respectively and the weighting of the subfields of each color is related to the levels of each color. The driving means are arranged for driving the light source associated with the color of the displayed subfield. In this arrangement, color filters per display element are not required any more, which improves the light efficiency of the display device. A further advantage of the uniform distribution of the lines of the different groups over the entire display is that a so-called color flash effect is reduced.

The color flash effect occurs in case a number of adjacent lines of the same group are addressed.

In an embodiment as specified in claim 9 the display device comprises a mirror on the side of the light guide facing away from the movable element. By applying this mirror in a display device that applies a color sequential addressing method, the light efficiency can be improved without introducing parallax in the display device. In conventional display devices using red, green and blue color filters, such a mirror may give rise to unacceptable parallax.

A further embodiment of the dynamic foil display device can be provided with a light emitting diode or a laser source. Important is that the light source can be switched on and off in a period much shorter than the period in which the light source emits light, associated with the lowest weight factor.

These and other aspects of the invention are apparent from and will be elucidated with reference to the embodiments described hereinafter.

In the drawings:

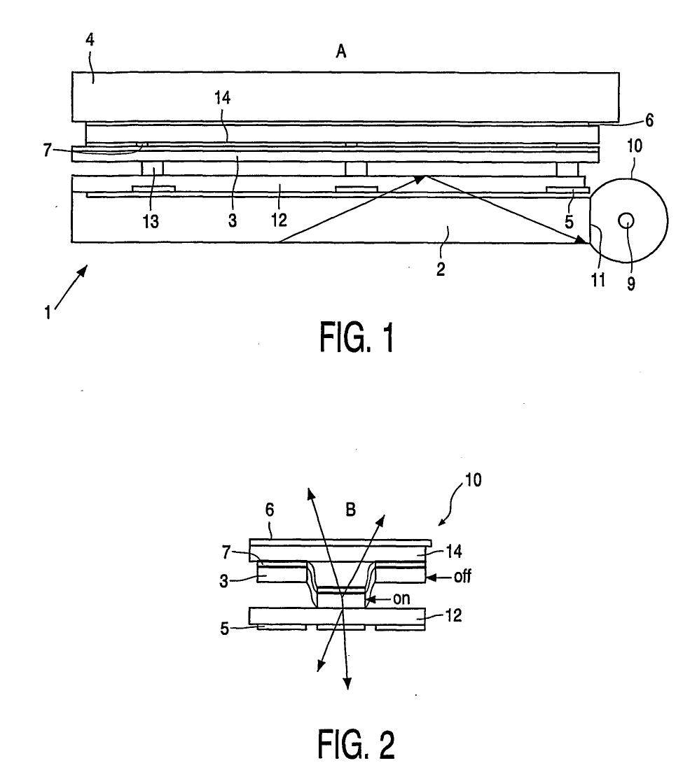

FIG. 1 is a cross-sectional view of a display device with a membrane,

FIG. 2 shows a detail of the display device shown in FIG. 1,

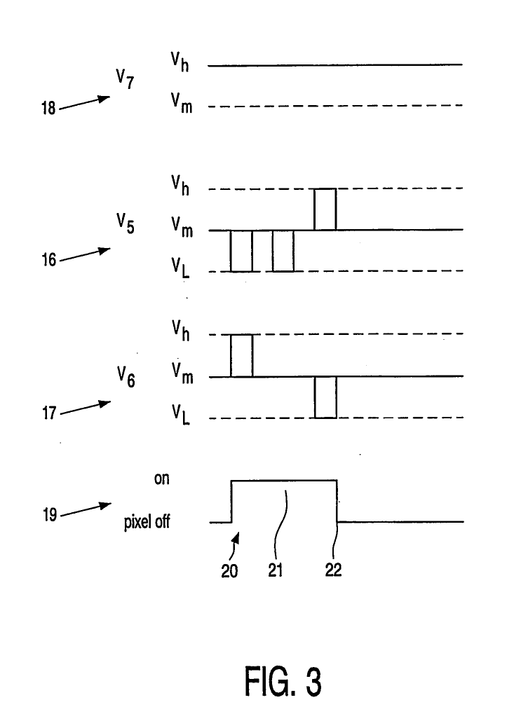

FIG. 3 shows an addressing scheme for the display device shown in FIG. 1,

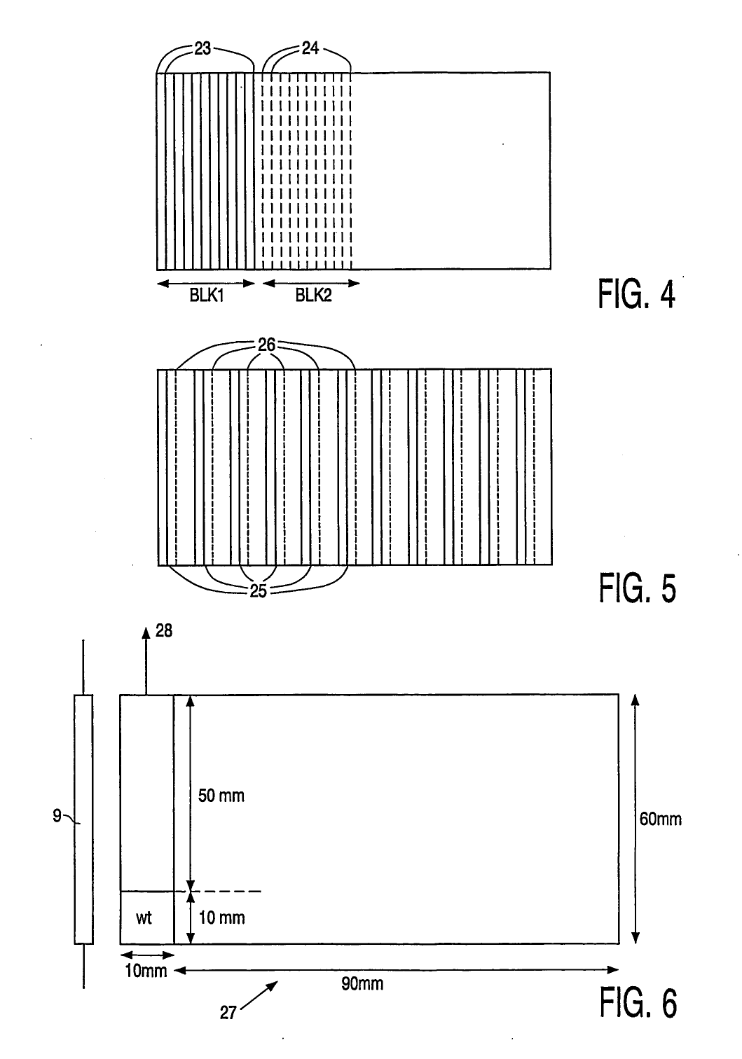

FIG. 4 shows a distribution of addressed selection electrodes in two groups in a conventional multi-line addressing scheme,

FIG. 5 shows an improved distribution of addressed selection electrodes in two groups in an improved multi-line addressing scheme,

FIG. 6 shows an example of a test image,

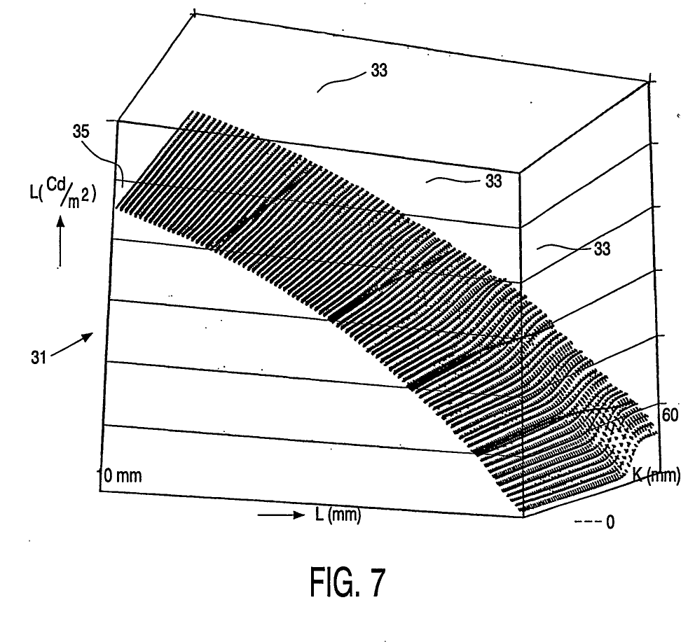

FIG. 7 shows a graph of a luminance distribution of the known multi-line addressing scheme,

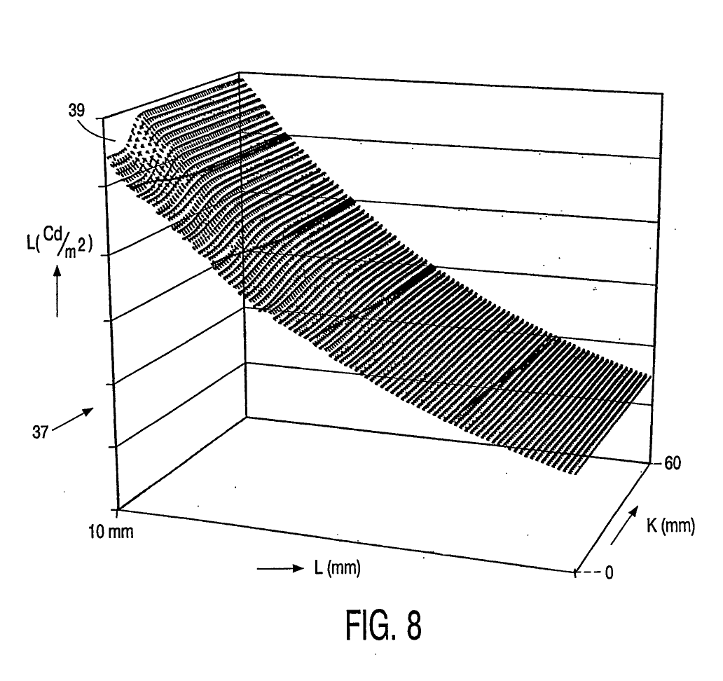

FIG. 8 shows a graph of a luminance distribution of the new multi-line addressing scheme,

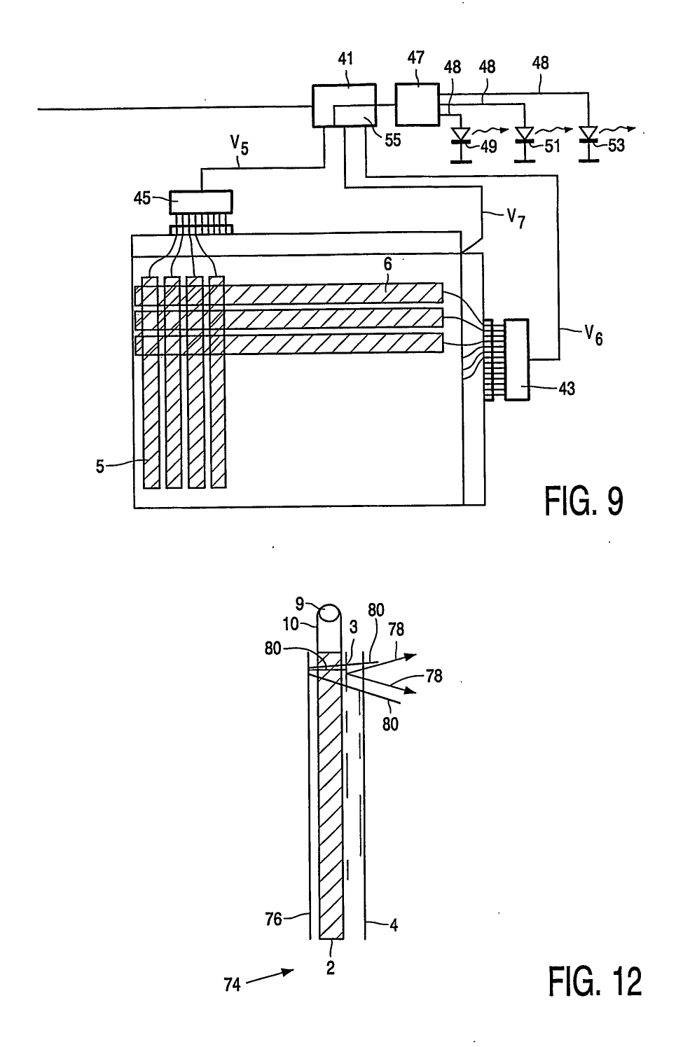

FIG. 9 shows schematically a sub-field modulated dynamic foil display,

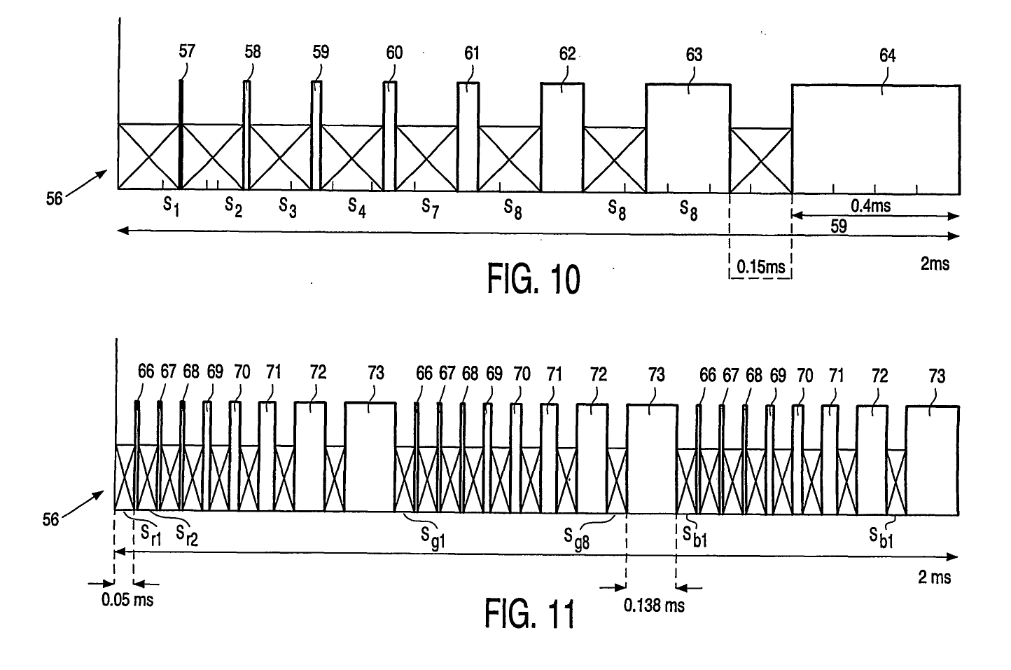

FIG. 10 shows an addressing sequence of a sub-field modulated dynamic foil device,

FIG. 11 shows an addressing sequence of a color-sequential sub-field modulated dynamic foil device, and

FIG. 12 shows a dynamic foil display device provided with a mirror behind the light guide.

The Figures are schematic and not drawn to scale, and, in general, like reference numerals refer to like parts.

FIG. 1 schematically shows a display device 1 comprising a light guide 2, a movable element 3 and a second plate 4. In this example, the movable element comprises a membrane. The membrane 3 may be made of a transparent polymer having a glass transition temperature of at least the operating temperature of the display device in order to prevent non-elastic deformation of the membrane. In practice the operating temperature of the display device is in the range between about 0 and 70 degrees Celsius. A suitable transparent polymer is, for example, parylene which has a glass transition temperature of 90 degrees Celsius.

Electrode systems 5 and 6 are arranged, respectively, on the surface of the light guide 2 facing the membrane 3 and on the surface of the second plate 4 facing the membrane. Preferably, a common electrode 7 is arranged on a surface of the membrane 3. The common electrode 7 can be formed by for example a layer of indium tin oxide (ITO). In this example, the light guide is formed by a light-guiding plate 2. The light guide 2 may be made of glass. The electrodes 5 and 6 form two sets of electrodes, which cross each other at an angle of preferably 90°. A set of selection electrodes or row electrodes 6 and a set of data electrodes or column electrodes 5. By locally generating a potential difference between the electrodes 5, 6 and the membrane 3, by applying voltages to the electrodes 5, 6 and electrode 7 on the membrane 3 in operation, forces pulling the membrane 3 against the light guide 2 or against the second plate 4 are locally exerted on the membrane.

The display device 1 further comprises a light source 9 and a reflector 10. Light guide 2 has a light input 11 in which light generated by the light source 9 is coupled in the light guide 2. The light source may emit white light, or light of any color, depending on the device. It is also possible that more than two light sources are present, for instance, a light source on two sides or on each side of the device. It is also possible to use light sources of different colors sequentially driven to form a white light display.

The membrane 3 is positioned between the light guide 2 and the second plate 4 by sets of spacers 13. Preferably, the electrode systems 5, 6 are covered by respective insulating layers 12 and 14 in order to preclude direct electrical contact between the membrane 3 and the electrodes. By applying voltages to the electrodes 5,6,7 an electric force F is generated, which pulls the membrane 3 against the electrode 5 on the light guide 2. The electrode 5 is transparent. The contact between the membrane 3 and the light guide 2 causes light to leave the light guide 2 and enter the membrane 3 at the location of the contact. The membrane scatters the light and a portion of the scattered light leaves the display device 1 via the transparent electrode 5 and the light guide 2 and another portion of the scattered light leaves through the second plate 4. It is also possible to use one set of transparent electrodes, the other being reflective, which increases the light output in one direction. The common electrode 7 comprises an electrically conducting layer. Such an electrically conducting layer can be a semi-transparent metal layer, such as a semi-transparent aluminum layer, a layer of a transparent electrically conducting coating such as indium tin oxide (ITO) or a mesh of metal tracks.

In operation, the light travels inside the light guide 2 and, due to internal reflection, cannot escape from it, unless the situation as shown in FIG. 2 occurs. FIG. 2 shows the membrane 3 lying against the light guide 2. In this state, part of the light enters the membrane 3. This membrane 3 scatters the light, so that it leaves the display device 1. The light can exit on both sides or on one side. In FIG. 2, this is indicated by arrows. In embodiments the display device comprises color-determining elements. These elements may be, for example, color filter elements allowing light of a specific color (red, green, blue, etc.) to pass. The color filter elements have a transparency of at least 20% for the spectral bandwidth of a desired color of the incoming light and for other colors a transparency in the range between 0 and 2% of the incoming light. Preferably, the color filter elements are positioned on the surface of the second plate 4 facing the light guide 2.

FIG. 3 shows an example of a known addressing scheme for the display device 1. This known addressing scheme is a so called multiple row addressing technique. A detailed description of this addressing technique can be found in international patent application WO 00/38163, which is an earlier patent application from the same applicant. This method of addressing is highly interesting since it allows to switch the membranes on or off with a single force acting on the structure. FIG. 3 shows three addressing states
a first addressing state “On” 20,
a second addressing state “nothing happens due to bi-stability”, 21
and a third addressing state “Off” 22.

The first graph 16 indicates the voltage on the column electrode 5, a second graph 17 indicates the voltage on the row electrode 6 and a third graph 18 indicates the voltage on the common electrode 7. It can be seen that during switching only a single force acts on the membrane. The fourth graph 19 indicates the on/off state of the corresponding display element.

For a VGA display consisting of 480 lines and 600 columns, the row electrodes 6 can be connected in, for example, 10 groups of 48 row electrodes. In an addressing period, the row drivers 43 supply scan pulses to 48 row electrodes 6 and data pulses Di to the column electrodes 5, so that only those portions of the membrane 3 corresponding to display elements that will scatter light in the subsequent display period move about in contact with the light guide 2.

In a conventional multi-line addressing scheme, spatially adjacent row electrodes 23,24 of respective groups BLK1, BLK2 are successively addressed one after the other and the subsequent groups BLK1, BLK 2 are sequentially activated as shown in FIG. 4.

In order to provide a more uniform gray scale image over the entire display, the row electrodes 25,26 are addressed so that the successively addressed row electrodes 25,26 are evenly distributed over the front area of the light guide 2 as shown in FIG. 5. FIG. 5 gives an example of a new multi-line addressing scheme of successively addressing spatially distributed row electrodes 25,26 of the respective groups over the display leading to an improved uniformity of the display wherein the successively addressed rows 25,26 of subsequent groups BLK10,BLK20 are evenly distributed, preferably, in such a way that a single row electrode 25 addressed in a first group BLK10 is in between two single row electrodes 26 addressed in a second group BLK20. Furthermore, it is assumed that the light is coupled in the light guide via one of the short sides of the display, so that the distribution of the row electrodes is in the main direction of the light flux from the light source in the light guide.

Alternatively, the row electrodes can be addressed in a way that a pair of adjacent row electrodes 25 addressed in a group BLK10 is in between two pairs of adjacent rows 26 of a second group BLK20.

A simulation result showing the difference between the conventional multi-line addressing scheme and the new multi-line addressing scheme is discussed with a test image as shown in FIG. 6. FIG. 6 shows an example of a test image 27 containing a white square WT of dimensions 10×10 mm2 in the left corner of a rectangle of dimensions 100×60 mm2, the rectangle further comprising a black rectangle 28 of dimensions 10×50 mm² and an adjacent gray rectangle GRS of 90×60 m².

FIG. 7 shows a first graph 31 of a simulation of a luminance distribution on a dynamic foil display device displaying the test image 27, in which there is a conventional multi-line addressing scheme of row electrodes 23,24 in a group BLK1,BLK2. The first graph 31 shows a relative difference of a factor 2 over the width of the display. Furthermore, a variation in the gray value is present within each group, and the transitions 33 between adjacent groups along the length of the display are noticeable as a step increase of the luminance, these step increases are caused by a later addressing instance of the new subsequent group, where, for that later addressing instances, no light losses have yet occurred due to the coupling out of light, except for a constant light loss due to absorption along the light guide 2.

FIG. 8 shows a second graph 37 of a simulation of a luminance distribution of the dynamic foil display device displaying the test image wherein the new multi-line addressing scheme of the row electrodes 25,26 in groups BLK10,BLK20 is applied, in which new multi-line addressing scheme the successively addressed row electrodes 25,26 of the groups BLK10,BLK20 are evenly distributed over the entire display. FIG. 8 shows that the relative difference of luminance along the width of the display is reduced to about 10%. Also the variance in the graph 37 along the length of the display has been smoothed compared to graph 31 of FIG. 7. Note that the origin of both graphs 31,37 in FIGS. 7 and 8 is at 10 mm distance of the side of the display, so where the gray rectangle GRS in the test image 24 begins.

The new multiline addressing scheme with uniform distribution of the addressed row electrodes 25,26 over the dynamic foil display is also advantageous in color sequential dynamic foil displays because of a reduction of the color flash effect.

FIG. 9 shows schematically an example of a sub-field modulated dynamic foil display 40 comprising a timing circuit 42, row and column drivers 43,46 and a lamp drive circuit 47. The timing circuit 42 receives information to be displayed on the display device. The timing circuit 42 divides a field period Tf of the display information into a predetermined number of consecutive subfields Tsf. Red, green and blue color filters associated with the display element together with a white light source. This light source can be for example a red, a green and a blue led 49,51,53 together with the lamp drive circuit 47 arranged for simultaneously driving each of the LEDs 49, 51,53 so that white light is emitted, composed from a mixture of the red, green and blue light of the LEDs 49,51, 53. Let us assume that the response time to switch the membrane 3 to the light guide 2 is τs. This is roughly half the time the membrane needs to cross the distance between the light guide and the front plate. A practical value for this response time is 3 μs. A subfield period comprises an addressing period, a display period and a reset period.

For a VGA display consisting of 480 lines and 600 columns, the row electrodes 6 can be divided into, for example, 10 groups of 48 row electrodes. In case a multi-line addressing scheme is applied in an addressing period, the row drivers 43 supply scan pulses to 48 row electrodes 6 and data pulses Di to the column electrodes 5 so that only those portions of the membrane 3 corresponding to display elements that will scatter light in the subsequent display period move about in contact with the light guide 2. To provide an improved image homogeneity, the successive addressed row electrodes 6 of one group are evenly distributed over the light guide in a direction coinciding with the main direction of the light flux from the light source in the light guide. This distribution of rows provides a more uniform gray scale image over the entire display. The time needed for this addressing period is N×τs, wherein N represents the number of row electrodes 6. In the consecutive display period, the row and column drivers 43,46 will supply a hold signal to the respective row and column electrodes 5,6. During the display period, the lamp drive circuit 47 supplies a drive pulse to the LEDs 49,51,53. The timing circuit 42 further associates a fixed order of weight factors Wf to the subfield periods Sf in every field period Tf. The lamp drive circuit 47 is coupled to the tirrng circuit 42 to supply the drive pulse Ld having a duration in conformity with the weight factors Wf, so that the amount of light generated by a display element corresponds to the weight factor. In the subsequent reset period, the row driver 43 supplies row-reset-pulses to the selected 48 row electrodes, and a data driver 46 supplies column-reset-pulses to the column electrodes 4 to release the selected portions of the membrane 3 which are in contact with the light guide from that light guide 2.

Furthermore, a subfield data generator 55 performs an operation on the display information Pi so that the data Di is in conformance with the weight factors Wf. In this way, only display elements in conformity with image data Di will scatter light in the display period.

In the display device three different states can then be distinguished:

an preparation phase, wherein the membrane will be in contact with the light guide or released in dependence on data Di. Therefore, the display elements are addressed on “a line at a time” basis and the voltage levels on the column electrodes will determine the position of the membranes;

a display phase, wherein a drive signal is supplied to the LEDs, the weight of an individual luminance bit will determine the presence of a light pulse during the display phase.

It may occur that light pulses Lpi,n in subsequent field periods are generated in accordance with the weight of the least and the most significant bit in the image information supplied; and

a reset phase, wherein all portions of the membrane of the display elements which are in contact with the light guide 2 are released from the light guide 2. This process is repeated for all 10 groups of the row electrodes 6.

FIG. 10 shows a control sequence for a group of 48 row electrodes of a sub-field modulated dynamic foil display device. The control sequence comprises addressing periods S1, . . . S8 and display periods 57, . . . , 64. For 480 lines and 256 gray values the total addressing time is 10×8×(48+1)×τs. In case τs equals 3 μs, the total addressing time is 11.76 ms and remains 8.24 ms for generating light. So, for a single group the total addressing time is 1.176 ms and remains 0.824 ms for generating light.

For a 256 gray value system and ro groups of row electrodes, in the display period the duration of the interval in which the LEDS are emitting light, associated with the least significant bit is approximately 3 μs and the duration of the interval in which the LEDs are emitting light, associated with the most significant bit is approximately 0.4 ms. For the LEDs a switching time lower than 0.1 μs is required. The applied LEDs 49,51,53 should withstand high peak loads. Instead of the LEDs 49,51,53 also solid state lasers can be applied.

This mode of addressing can be useful for displaying VGA or SVGA images, NTSC or PAL television images.

In another embodiment a color sequential display method is applied in the sub-field modulated dynamic foil display device.

Schematically, this color sequential subfield modulated dynamic foil display device comprises similar circuits 40,42,43,45,47 to the dynamic foil display device 40 as described with relation to FIG. 9, except that the timing circuit 42 is now arranged to divide a field period Tf of the display information into a predetermined number of consecutive subfields Tsf associated with red, green and blue information, respectively, of the image to be displayed. The lamp drive circuit 47 is arranged for driving the LED in the color of the display period associated with the subfield corresponding to the red, green and blue image information, respectively. In this display device, the required response time to bring a portion of the membrane 3 to the light guide 2 should be 1 μs. This is roughly half the time the membrane needs to cross the distance between the light guide 2 and the front plate 4. A subfield period comprises an addressing period, a display period and a reset period.

For a VGA display the row electrode can again be divided into, for example, 10 groups of 48 lines. In an addressing period, the row drivers 43 supply scan pulses to 48 row electrodes 6 and the column drivers 45 supply data pulses Di to the column electrodes 5 so that only those portions of the membrane 3 corresponding to display elements that will scatter light in the subsequent display period move about in contact with the light guide 2. Preferably, the row electrodes 5 of each group have been evenly distributed over the light guide 2. The time needed for this addressing period is 10×3×8(48+1)×τs. In the consecutive display period, the row and column driver 43,45 will supply a hold signal to the respective row and column electrodes 5,6. During the display period, the lamp drive circuit 47 supplies a drive pulse to the red, green or blue LED 49,51,53 in accordance with the color of the processed subfield. The timing circuit 42 further associates a fixed order of weight factors Wf to the subfield periods Sf in every field period Tf. The lamp drive circuit 47 is coupled to the timing circuit 42 to supply the drive pulse Ld having a duration in conformity with the weight factors Wf, so that the amount of light generated by a display element corresponds to the weight factor. In the subsequent reset period, the row driver 43 supplies a row-reset-pulse to the selected 48 row electrodes, and a data driver 46 supplies column-reset-pulses to the second electrodes or column electrodes 5 for releasing the portions of the membrane 3 from the light guide 2. This addressing requires only a single addressing period. This process is repeated for all subfields for red, green and blue information respectively and for all groups. A subfield data generator 55 performs an operation on the display information Pi, so that the data Di is divided into subfields associated with red, green and blue colors and in conformity with the weight factors Wf. In this way, only display elements in conformity with image data Di will scatter red, green or blue light in the display period.

FIG. 11 shows a control sequence for a group of 48 row electrodes of a color sequential sub-field modulated dynamic foil display device. The control sequence 65 comprises addressing periods Sr1, . . . Sr8, Sg1, . . . , Sg8, Sb1, . . . Sb8 and display periods 66, . . . , 73 For 480 lines and a 256 gray value system the total addressing time in the sequential color display device is 10×3×8(48+1)×τs. In case τs equals 1 μs the total addressing time is 11.7 ms and remains 8.3 ms for generating light. Per group this last interval for generating light is 0.83 ms. The interval for generating light in one of the three colors is then 0.277 ms. For a 256 gray value system the duration of the interval in which one of the LEDs is radiating light associated with the least significant bit is approximately 1.1 μs in the display period and the duration of the period in which one of the LEDs is radiating light associated with the most significant bit is approximately 138 μs. For LEDs or solid state laser a switching time is lower than 0.1 μs. It is clear that the light sources should withstand high peak loads. It has to be noted that to avoid a loss of efficiency an integrated intensity Is of the LEDs should be comparable with the intensity Ib of a continuous light source. In practice this means that the intensity of the LEDs Ils should be
Ils 0.824=Ib 20 ms [symbol] Ils=24.27 Ib.

This mode of addressing can be useful for displaying VGA or SVGA images, NTSC or PAL television images.

Furthermore, in order to increase the brightness with an additional factor two a mirror can be positioned at the side of the light guide facing away from the membrane.

FIG. 12 shows a dynamic foil display device 74 comprising a mirror 76 behind the light guide 2 at the side turned away from the second plate 4. The portion of the membrane 3 scatters a first portion 78 of the light in a direction to the viewer and a second portion 80 backwards to the mirror 76. The mirror 76 reflects the second portion 80 of the direction of the viewer.

It will be obvious that many variations are possible within the scope of the invention without departing from the scope of the appended claims.

1. A dynamic foil display device for displaying image information comprising a light source for generating light,
a light guide for transporting the generated light,
a plurality of controllably movable elements associated with the light guide for locally bringing, in an active state, said movable element into contact with the light guide for coupling out light from the light guide so as to form a picture;
selection means comprising selection electrodes and data electrodes arranged in rows and columns respectively for controlling the movable elements in correspondence with received image information, wherein the selection electrodes are interconnected in a first and a second group of rows;
and driving means being arranged to provide the image information to the selection means corresponding to the rows of the first group and the rows of the second group respectively, characterized in that the selection electrodes of the first group and the selection electrodes of the second group are distributed evenly in a lateral direction, parallel to a main direction of the light flux in the light guide.

2. A display device as claimed in claim 1, wherein a selection electrode of the first group is located between neighbouring selection electrodes of the second group.

3. A display device as claimed in claim 1, wherein the display device comprises timing means for dividing a field period of the received display information into consecutive subfields having an addressing period preceding a display period, the timing means further generating with the field period a predetermined order of weight factors each associated with a corresponding one of the display periods; a light source driver which, upon receiving a drive signal, activates the light source during the display period, and a driver circuit for supplying a drive signal corresponding to the weight factors.

4. A display device as claimed in claim 4, wherein the received display information comprises data words having binary coded weights, and the timing means are adapted to generate the weight factors of the display periods within a field period so that each weight factor corresponds with one of the weights of the bits.

5. A display device as claimed in claim 5, wherein the light source comprises a first light source of a first color and a second light source of a second color and the timing means are further arranged for dividing the field period of the received display information into consecutive first sub-field periods associated with the first color, and consecutive second sub-field periods associated with the second color, and the drive circuit is further arranged for supplying the drive signal corresponding to the weight factors to the light source with the color associated with the sub-field period.

6. A display device as claimed in claim 1 wherein the display device comprises a reflective element at the side of the light guide turned away from the movable element.

7. A display device as claimed in claim 1, wherein the light source comprises a light emitting diode.

8. A display device as claimed in claim 1, wherein the light source comprises a laser.

9. A method of driving a flat panel display in a sub-field mode, the flat panel display comprising a plurality of picture elements arranged in a matrix of rows and columns, selection electrodes and data electrodes associated with picture elements in a row or column, and a light source for generating light, the display elements being arranged, when in an active mode, for transmitting light from the light source in conformity with received display information, the method comprising a step of sequentially addressing the selection electrode in a first group and a second group respectively, characterized in that the method comprises a further step of evenly distributing the addressed selection electrodes in a direction parallel to the main direction of the light flux in the light guide.
